(19) United States
(12) Patent Application Publication
(10) Pub. No.: US 2016/0132857 A1
(43) Pub. Date: May 12, 2016

(54) SYSTEMS AND METHODS FOR DETERMINING AN ACTUAL GEOGRAHPIC LOCATION OF A PAYMENT TRANSACTION

(71) Applicant: MasterCard International Incorporated, Purchase, NY (US)

(72) Inventors: Kenny Unser, Fairfield, CT (US); Jean-Pierre Gerard, Croton-On-Hudson, NY (US)

(21) Appl. No.: 14/535,893

(22) Filed: Nov. 7, 2014

(51) Int. Cl. G06Q 20/22; H04L 29/08

(52) U.S. Cl. CPC G06Q 20/22; H04L 67/16

(57) ABSTRACT

A computer-implemented method for determining an actual geographic location of a payment transaction is provided. The method uses an actual geographic location analyzer computer device in communication with a memory. The method includes storing, in the memory, merchant data including a merchant physical address, receiving transaction data for a payment card transaction wherein the transaction data includes a merchant identifier, determining a merchant physical address associated with the merchant identifier, determining, by the actual geographic location analyzer computer device, an actual transaction location. The actual transaction location identifies where the payment card transaction was initiated. The method also includes determining, by the actual geographic location analyzer computer device, a locational difference between the merchant physical address and the actual transaction location.

### BACKGROUND OF THE DISCLOSURE

The field of the disclosure relates generally to improving merchant business decisions, and more specifically to methods and systems for determining an actual geographic location where a card-present transaction occurred.

When processing payment card transactions, transaction data is sent and received by multiple parties. Parties in such transactions include merchants, acquirer banks, issuer banks, and payment networks or payment processors. Transaction data may include a transaction amount, transaction identifier, product identifier, transaction date and time, merchant identifier, and cardholder identifier. Payment processors may store and process a merchant's transaction data. Processed transaction data may be returned to merchants to improve their business models. For example, transaction data may be used to identify a peak time of customer activity or determine popularity of a product.

Some merchants have nomadic business models. Such merchants may be referred to as nomadic merchants. Nomadic business models can be described as conducting or originating transactions from multiple geographic locations. In this example, transactions are limited to only those transactions initiated in the presence of the merchant (a/k/a card present transactions), not online transactions. Nomadic merchants may include vendors at craft fairs, in-home businesses, taxis/limousines, and trade show exhibitors. Unfortunately, the actual geographic location of the payment card transaction (i.e., the location where the card present transaction is originating), herein referred to as the actual transaction location, is not reported in the transaction data. Rather, the merchant physical address (i.e., a registered business address) is provided, which may or may not be the actual geographic location that the transaction originated from, for example when the transaction originates from a mobile kiosk away from the registered business location. In other words, there may be a discrepancy between where the business has registered its address, and where the transactions are actually taking place with the business. This raises issues for certain merchants, for example, nomadic merchants (i.e., merchants with mobile business locations). In other words, transactions involving nomadic merchants are inaccurately reported in transaction data as occurring at a merchant physical address, such as a storefront address, and not reported as being associated with the actual geographic location where the transactions occur or originate. Accordingly, to better service nomadic merchants, payment processors may prefer to receive an actual geographic location of the transaction as opposed to a merchant storefront address.

### BRIEF DESCRIPTION OF THE DISCLOSURE

In one aspect, a computer-implemented method for determining an actual geographic location of a payment transaction is provided. The method uses an actual geographic location analyzer computer device in communication with a memory. The method includes storing in the memory merchant data including a merchant physical address, receiving transaction data for a payment card transaction wherein the transaction data includes a merchant identifier, determining a merchant physical address associated with the merchant identifier, and determining by the actual geographic location analyzer computer device an actual transaction location. The actual transaction location identifies where the payment card transaction was initiated. The method also includes determining, by the actual geographic location analyzer computer device, a locational difference between the merchant physical address and the actual transaction location.

In another aspect, an actual geographic location analyzer computer device used to determine an actual geographic location of a payment transaction. The actual geographic location analyzer computer device includes a processor communicatively coupled to a memory device. The processor is programmed to store merchant data including a merchant physical address, receive transaction data for a payment card transaction wherein the transaction data includes a merchant identifier, determine a merchant physical address associated with the merchant identifier, and determine an actual transaction location. The actual transaction location identifies where the payment card transaction was initiated. The processor is also programmed to determine a locational difference between the merchant physical address and the actual geographic location.

In a further aspect, at least one non-transitory computer-readable storage media having computer-executable instructions embodied thereon is provided. When executed by an actual geographic location analyzer computer device having at least one processor coupled to at least one memory device, the computer-executable instructions cause the processor to store merchant data including a merchant physical address, receive transaction data for a payment card transaction wherein the transaction data includes a merchant identifier, determine a merchant physical address associated with the merchant identifier, and determine an actual transaction location. The actual transaction location identifies where the payment card transaction was initiated. The instructions also cause the processor to determine a locational difference between the merchant physical address and the actual geographic location.

### BRIEF DESCRIPTION OF THE DRAWINGS

The figures listed below show example embodiments of the methods and systems described herein.

FIGS. 1-8 show example embodiments of the methods and systems described herein.

FIG. 1 is a schematic diagram illustrating an example multi-party transaction card industry system for enabling payment-by-card transactions in which merchants and card issuers do not need to have a one-to-one special relationship.

FIG. 2 is a simplified block diagram of an example system including an actual geographic location analyzer computer device used for determining an actual geographic location of a transaction in accordance with one example embodiment of the present disclosure.

FIG. 3 illustrates an example configuration of a client system shown in FIG. 2, in accordance with one embodiment of the present disclosure.

FIG. 4 illustrates an example configuration of the server system 212 shown in FIG. 2, in accordance with one embodiment of the present disclosure

FIG. 5 is a simplified data flow diagram of a system for determining the actual geographic location of a transaction in accordance with the system shown in FIG. 2.

FIG. 6 is a schematic diagram illustrating a system for obtaining the actual geographic location of the transaction using the system shown in FIG. 2, in accordance with one embodiment of the disclosure.

FIG. 7 is a flowchart illustrating an example of a process of determining the actual geographic location of a payment transaction using the system shown in FIG. 2, in accordance with one embodiment of the disclosure.

FIG. 8 is a diagram of components of one or more example computing devices that may be used in system 200 shown in FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

Nomadic merchants may desire the actual geographic location that a transaction occurred at to improve their business models. For example, a nomadic merchant may travel and conduct business across different geographic regions. The nomadic merchant may desire information detailing their revenue at different locations to be able to compare to their expenses. Using this information, the nomadic merchant may determine business opportunities or concerns in a particular geographic region.

In some examples, a merchant may conduct business at a single location, such as a storefront. This location may be referred to as the merchant physical address. In other examples, a merchant may conduct business at multiple locations. In these examples, the merchant may report the merchant physical address to be the location the merchant conducts the majority of their business or the merchant may report a corporate address as the merchant physical address.

Alternately, in a second example, the actual transaction locations may be used to address specific business opportunities or concerns. In some examples, a merchant, such as a product salesman, may desire to determine which sales occurred at a storefront versus at a trade show. In other examples, a merchant may attend different craft fairs at different locations. The merchant may use the actual geographic location of the transaction to determine the revenue earned at each craft fair. A food truck vendor may sell at many different locations on many different days of the week and desire to determine which locations are the most profitable. In some embodiments, the actual transaction locations may be used for trade area analysis, market saturation analysis, business impact analysis, and tax studies.

Accordingly, in at least some cardholder-initiated financial transactions, payment processors (e.g., payment networks for processing and storing payment card transactions) may desire the actual geographic location of the payment card transaction to better service nomadic merchants. Merchants having nomadic business models may be referred to as nomadic merchants. Nomadic business models can be described as conducting or originating transactions from multiple geographic regions, wherein at least some of these geographic regions do not include a merchant brick-and-mortar store location. Transactions, as described herein, are limited to only include transactions occurring in front of the merchant (a/k/a card present transactions), not online transactions.

Nomadic merchants may be exemplified in many forms. Examples include, but are not limited to a product salesman travelling and conducting business at product shows across multiple states, a taxi driver driving passengers home from various nightclubs across a city, and a jeweler selling products at different craft fairs at different locations.

Upon a transaction between a merchant and a consumer, transaction data is transmitted to a payment network. Transaction data may include transaction amount, transaction identifier, product identifier, transaction date and time, merchant identifier, and cardholder identifier. Unfortunately, the actual geographic location of the payment card transaction (i.e., the location where the card present transaction is originating from), herein referred to as the actual transaction location, may not be reported in the transaction data. Typically, the merchant physical address is provided (or the merchant identifier provides a look-up that allows the payment network to retrieve the merchant physical address), which may or may not be the actual transaction location of the transaction. In many examples, transactions involving nomadic merchants may be inaccurately reported as originating at the merchant physical address, such as a storefront address, and not reported as being associated with the actual geographic location where the transactions occur or originate.

As a result, to better service nomadic merchants, it may be advantageous for payment processors to obtain the actual transaction location for each transaction. The actual transaction locations may allow nomadic merchants to optimize their resources and focus on the most profitable ventures. The actual transaction location may also allow nomadic merchants to bring additional products to a craft fair or trade show based upon transaction data from a previous year. Additionally, the actual transaction location may allow nomadic merchants to determine the most profitable geographic region to expand into.

Accordingly, the systems and methods described herein include determining an actual transaction location. The systems and methods described herein are configured to provide an actual geographic location analyzer service. The systems and methods described herein are implemented using an actual geographic location analyzer (AGLA) computer device. The AGLA computer device is configured to: (i) store merchant data including a merchant physical address; (ii) receive transaction data for a payment card transaction wherein the transaction data includes a merchant identifier; (iii) determine a merchant physical address associated with the merchant identifier; (iv) determine an actual transaction location, wherein the actual transaction location identifies where the payment card transaction was initiated; and (v) determine a locational difference between the merchant physical address and the actual transaction location.

In one example embodiment, a merchant registers with the AGLA computer device before receiving access to an actual geographic location analyzer service. When a payment network receives an authorization request message containing transaction data from the merchant, the payment network transmits the authorization request message to the AGLA computer device. In some embodiments, the payment network determines whether the merchant is registered with the actual geographic location analyzer service before transmitting the transaction data. In other embodiments, the payment network automatically transmits the transaction data to the AGLA computer device. In other embodiments, the AGLA computer device is associated with the payment network and automatically receives transaction data as a part of normal processing of payment transactions. In the example embodiment, the authorization request message is associated with a payment card transaction where the payment card was present when the transaction occurred. Additionally, a third party, such as a government agency, may register the merchant with the AGLA computer device for the actual geographic location analyzer service. The transaction data represents the data from the processing of a payment transaction and includes one or more transaction data elements. Transaction data elements may include, but are not limited to, transaction amounts, transaction volumes, transaction identifiers, product identifiers, cardholder residence locations, merchant physical addresses, transaction dates and times, merchant identifiers, and cardholder identifiers.

The merchant may also use actual geographic location analyzer service for transactions that occurred prior to the merchant's registration. When an authorization request message is received by the payment network, the payment network may store the data for the transactions as historical transaction data with historical transaction data elements. Historical transaction data elements may include, but are not limited to, transaction amounts, transaction volumes, transaction identifiers, product identifiers, cardholder residence locations, merchant physical addresses, transaction dates and times, merchant identifiers, and cardholder identifiers. In at least one example embodiment, historical transaction data may be stored in a database associated with the payment network. In alternative embodiments, historical transaction data may be stored in databases associated with a merchant bank or an issuer. After the merchant registers with the AGLA computer device for the actual geographic location analyzer service, the AGLA computer device may request historical transaction data from the payment network or the database where historical transaction data is being stored.

“Historical transaction data” represents previously processed transaction data from previous consumer transactions. In at least one example, historical transaction data may be stored in a transaction data database associated with the AGLA computer device. In alternative examples, historical transaction data may be stored in other systems or received from a payment network computer system associated with the payment network. The historical transaction data may include, for example, transaction amounts, transaction identifiers, product identifiers, actual transaction locations, merchant physical addresses, transaction dates and times, merchant identifiers, cardholder numbers, and locational differences.

The AGLA computer device receives transaction data associated with a plurality of payment card transactions wherein the transaction data includes a plurality of merchant identifiers each associated with a merchant physical address. The AGLA computer device may process and store the transaction data. In the example embodiment, during processing of the transaction data, the AGLA computer device may compare a merchant identifier associated with the transaction data with merchant identifiers associated with historical transaction data. If merchant identifiers match, the AGLA computer device may group the transaction data together with historical transaction data. In some examples, the AGLA computer device may use this grouping to calculate a merchant's yearly revenue. In other examples, the AGLA computer device may use this grouping to calculate the revenue earned by a particular product. To calculate this revenue, the AGLA computer device may use the transaction amounts, product identifiers, transaction volumes, and merchant identifiers.

In some examples, received transaction data may not include all transaction data elements and the AGLA computer device may use historical transaction data to infer the missing elements. For example, transaction data elements may not include a merchant physical address. The AGLA computer device may determine a merchant physical address from historical transaction data by comparing historical transaction data elements and transaction data elements. In other words, the AGLA computer device may find similar elements, such as a merchant identifier, between the data elements. The AGLA computer device may add the transaction data's merchant physical address from the historical transaction data's merchant physical address.

In some example embodiments, the actual transaction location is determined from input location data which can include Global Positioning Service (GPS) data, wherein the GPS function is provided by the merchant's POS device or the cardholder's mobile device. In other embodiments, the input location data may include by cell network triangulation, physical addresses from mapping software, social media “check-ins”, and physical addresses associated with IP address. Additionally, the actual transaction location may be provided by the merchant or third party, such as taxi records or craft fair locations, by inputting this data into the AGLA computer device.

In an example embodiment, the AGLA computer device enhances the transaction data to include the actual transaction location. In some embodiments, the actual transaction location replaces the merchant physical address, which is associated with the merchant at the payment network. In yet other examples, the actual transaction location may be an additional data element associated with the transaction data.

In another embodiment, the merchant reports the actual transaction location after the transaction is completed. The merchant submits a transaction identifier, a merchant identifier, and an actual transaction location via a client device. The AGLA computer device compares the merchant's submitted transaction identifier and merchant identifier with the received historical transaction data. When the transaction associated with the transaction identifier is determined, the AGLA computer device enhances the transaction data to include the actual transaction location. A person of ordinary skill in the art would recognize linking the merchant reported actual transaction location and historical transaction data may be accomplished many other ways, for example, but not limited to, the merchant submitting a date of purchase and a time of purchase or the merchant submitting a date of purchase and an amount of purchase.

In another embodiment, the AGLA computer device receives actual transaction locations from a third party. Examples of third parties may include cell phone providers, event organizers, GPS providers, and acquirer banks. In some examples, the third party transmits, at the time of the transaction, the actual transaction location to the AGLA computer device. In other examples, the AGLA computer device may receive, after receiving the transaction data, the actual transaction location from the third party. In yet other examples, the third party may collect and maintain the actual transaction locations for a plurality of transactions. The third party may create a report of the actual transaction locations for the plurality of transactions and deliver the report to the AGLA computer device. The report may be delivered to the AGLA computer device periodically or upon request.

In some embodiments, the actual transaction location may include latitude and longitude information, physical street addresses, geographic region, town, county, and state. In some examples, the actual transaction location may contain a single geographic data point, such as a physical address. In other examples, the actual transaction location may contain multiple geographic data points. In yet other examples, the actual transaction location may contain a geographic region, for example, a county, city, state, or other geographic region. The geographic region may also contain an area with boundary lines, such as a latitude line or a longitude line. Additionally, the actual transaction location may contain an event identifier, which contains data such as an event name, event dates including a begin date and an end date, and additional event organizer information.

The AGLA computer device may determine a locational difference between the merchant physical address for each payment card transaction and the actual transaction location. The locational difference is processed through the computer system and the actual transaction location is used to identify trends. The historical transaction data may be enhanced to include the locational difference. In an example embodiment, the AGLA computer device may store the locational difference as a Boolean flag. In this instance, the AGLA computer device may compare the merchant physical address for each payment card transaction and the actual transaction location. If the merchant physical address and actual transaction location are different, the payment computer system may set a Boolean flag. In some examples, the merchant physical address and the actual transaction location received by the computer system may be a single geographic data point, such as a physical address. However, in other examples, the computer system may receive the merchant physical address as a single geographic data point, but the actual transaction location received may be a latitude and longitude. The AGLA computer device may modify the latitude and longitude to an address. In yet other examples, the computer system may receive the merchant physical address as a single geographic data point and receive the actual transaction location as a county. In other examples, the locational difference between the merchant physical address and the actual transaction location may be stored as a vector indicating the distance and direction between the two locations. The distance may be computed by calculating the driving distance between the two points. This can be useful when physical barriers, such as mountains or bodies of water, would skew the actual distance between the two points.

The AGLA computer device may deliver a report based upon the locational difference. More specifically, the AGLA computer device processes the transaction data, the actual transaction location, and the locational difference to generate a report. The AGLA computer device may standardize the actual transaction locations. In one embodiment, the AGLA computer device may convert the actual transaction location and merchant physical address to latitude and longitude. In another embodiment, the AGLA computer device may convert the actual transaction location and merchant physical address to a geographic region.

The AGLA computer device may analyze and identify trends from the historical transaction data and the actual transaction locations using algorithms. The trends may be used to identify business concerns and opportunities. Trends may include historical transaction data elements. Further, historical transaction data elements may be combined to allow the AGLA computer device to distinguish characteristics in different conditions. For example, the actual transaction location may be combined to include all transactions outside the merchant physical address. A first illustrative trend is displayed below (Table 1):

TABLE 1

| Location of | Transaction | Transaction |
|---|---|---|
| Sale for a | Volumes for | amounts for |
| Merchant | previous year | previous year |
| Location | 100,000,000 | $200,000 |
| Outside of | | |
| Merchant | | |
| Physical | | |
| Address | | |
| Merchant | 5,000,000 | $100,000 |
| Physical | | |
| Address | | |

Table 1 serves as a first illustration of a simple form of a trend. The AGLA computer device may group the historical transaction data by identical merchant identifiers. The AGLA computer device may further group the historical transaction data by transactions occurring within the previous year. Transaction volumes and transaction amounts may be added together from this further grouping. The Boolean flag locational difference may then differentiate between location outside of merchant physical address and the merchant physical address for transaction volumes and transaction amounts. A second illustrative trend is displayed below (Table 2):

TABLE 2

| Location of | Transaction | Transaction |
|---|---|---|
| Sale for | Volumes for | amounts for |
| Merchant | Event | Event |
| Craft Fair 1 | 1,000 | $5,000 |
| Craft Fair 2 | 2,500 | $2,500 |
| Craft Fair 3 | 400 | $1,000 |
| Craft fair 4 | 1,300 | $2,000 |

The example trends indicated in Tables 1 and 2 are provided for explication only. They are not restrictive and it should be understood that the trends generated and used by the AGLA computer device may be significantly different and more complex than the trends illustrated above. In the example of Table 2, the AGLA computer device may group the historical transaction data by identical merchant identifiers. The AGLA computer device may further group the historical transaction data by event identifier, such as event name. Transaction volumes and transaction amounts may be added together from this further grouping.

In further examples, the AGLA computer device may analyze historical transaction data to identify patterns of characteristics. Where characteristics significantly deviate from the normal characteristics, the AGLA computer device may flag or otherwise identify such deviations.

The trends and deviations may be used to identify business concerns and opportunities. The AGLA computer device may create and deliver a report to the merchant. The report may be delivered to the merchant upon request or periodically. Additionally, the AGLA computer device may deliver the report upon a numerical accumulation of the locational differences. In other words, the locational differences between the merchant address and the actual transaction location for a particular merchant identifier may be accumulated. Once the locational differences reach a numerical value, the AGLA computer device may deliver the report to the merchant.

In some embodiments, the AGLA computer device determines if the payment transaction was a card present transaction before looking for an actual transaction location. For example, if the AGLA computer device determines that the payment transaction was an online ecommerce transaction, then the AGLA computer device does not determine an actual transaction location for the payment transaction.

The methods and systems described herein may be implemented using computer programming or engineering techniques including computer software, firmware, hardware, or any combination or subset. As disclosed above, at least one technical problem with known systems is that there is no efficient way to determine where payment transactions took place for nomadic merchants. The systems and methods described herein address that technical problem. The technical effect of the systems and processes described herein is achieved by performing at least one of the following steps: (a) storing merchant data including a merchant physical address; (b) receiving transaction data for a payment card transaction wherein the transaction data includes a merchant identifier; (c) determining a merchant physical address associated with the merchant identifier; (d) determining an actual transaction location, wherein the actual transaction location identifies where the payment card transaction was initiated; and (e) determining a locational difference between the merchant physical address and the actual transaction location. The resulting technical effect is that more accurate data identifying the actual geographic location of a payment transaction is captured and processed over the payment network such that the subscribing merchant is then able to receive more accurate data as to where transactions are being performed.

Described herein are computer systems such as AGLA computer devices and related computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the determination and analysis of characteristics of devices used in payment transactions.

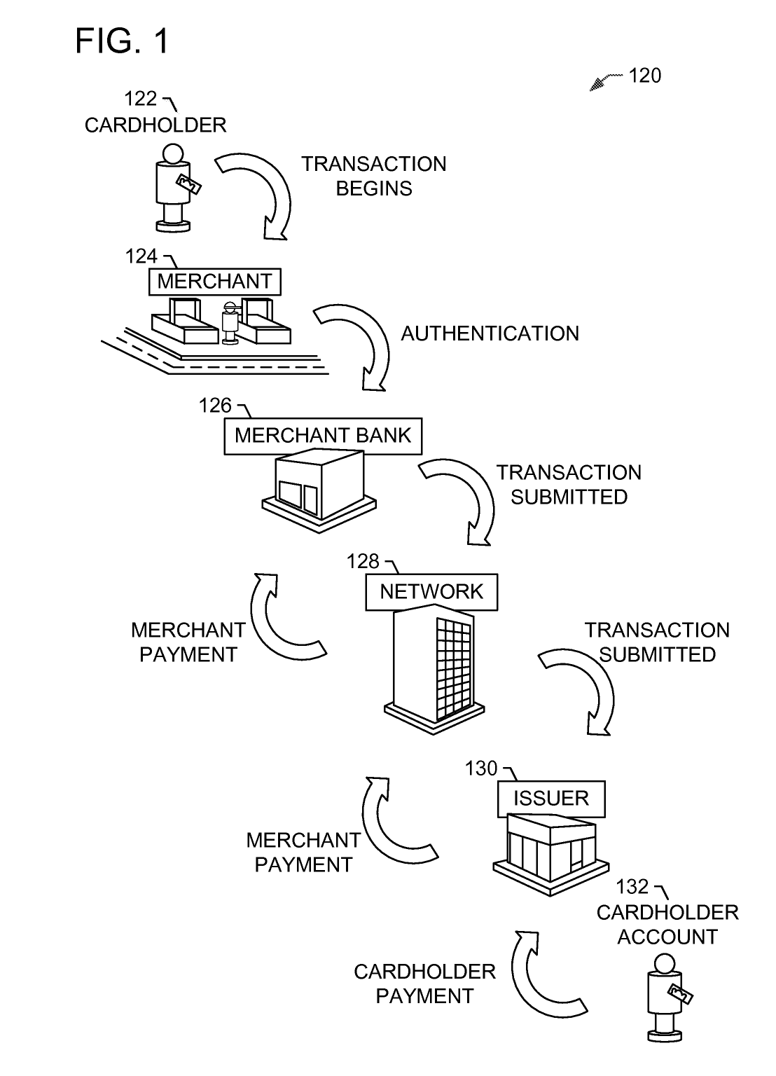

FIG. 1 is a schematic diagram illustrating an example multi-party transaction card industry system 120 for enabling payment-by-card transactions in which merchants 124 and card issuers 130 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128 (also known as a payment network), computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

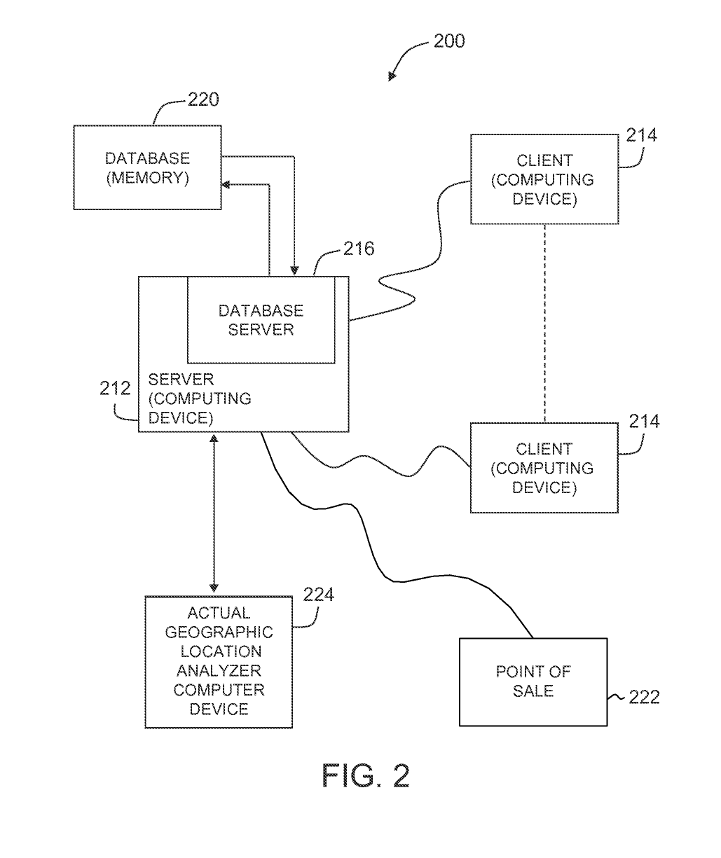

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 including an actual geographic location analyzer computer device used for determining the actual geographic location of a transaction in accordance with one example embodiment of the present disclosure. In the example embodiment, system 200 may be used for performing payment-by-card transactions received as part of processing cardholder transactions. In addition, system 200 is a payment processing system that includes an actual geographic location analyzer (“AGLA”) computer device 224 configured to determine where payment card transactions occurred. As described below in more detail, AGLA computer device 224 is configured to store merchant data which includes a merchant physical address, receive transaction data for a payment card transaction where the transaction data includes a merchant identifier, determine a merchant physical address associated with the merchant identifier, determine an actual transaction location that identifies where the payment card transaction was initiated, and determine a locational difference between the merchant physical address and the actual transaction location.

In an example embodiment, AGLA computer device 224 may store the locational difference as a Boolean flag. In this embodiment, AGLA computer device 224 may compare the merchant physical address for each payment card transaction and the actual transaction location. If the merchant physical address and actual transaction location are different, the payment computer system may set a Boolean flag representing that there is a difference between the two locations. In other embodiments, the locational difference between the merchant physical address and the actual transaction location may be stored as a vector indicating the distance and direction between the two locations. For example, AGLA computer device 224 receives the GPS location where the transaction occurred and compares that location with the merchant physical address and calculated the distance and direction between the actual transaction location and the merchant physical address. In still other embodiments, the locational difference may be computed by calculating the driving distance between the two points. In these embodiments, AGLA computer device 224 uses a driving direction program or service to calculate the route between the actual transaction location and the merchant physical address. This can be useful when physical barriers, such as mountains or bodies of water, would skew the actual distance between the two points. In other embodiments, the locational difference may be stored as latitude and longitude information, physical street addresses, geographic region, town, county, or state based on the actual transaction location.

In the example embodiment, client systems 214 are computers that include a web browser or a software application, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment.

A database server 216 is communicatively coupled to a database 220 that stores data. In one embodiment, database 220 includes transaction information from a plurality of cardholders and paths based on those transactions. In the example embodiment, database 220 is stored remotely from server system 212. In some embodiments, database 220 is decentralized. In the example embodiment, a person can access database 220 via client systems 214 by logging onto server system 212, as described herein.

AGLA computer device 224 is communicatively coupled with the server system 212. AGLA computer device 224 can access the server system 212 to store and access data and to communicate with the client systems 214 through the server system 212. In some embodiments, AGLA computer device 224 may be associated with, or is part of the payment system, or in communication with the payment card system 120, shown in FIG. 1. In other embodiments, AGLA computer device 224 is associated with a third party and is merely in communication with the payment card system 120. In some embodiments, AGLA computer device 224 may be associated with, or be part of merchant bank 126, interchange network 128, and issuer bank 130, all shown in FIG. 1.

One or more point of sale systems 222 are communicatively coupled with the server system 212. The one or more point of sale systems 222 can be merchants 124 shown in FIG. 1, where the point of sale systems 222 are communicatively coupled with the server system through the payment card system 120. In the example embodiment, point of sale systems 222 may be, but are not limited to, machines that accept card swipes, online payment portals, or stored payment card numbers for recurring transactions.

In some embodiments, server system 212 may be associated with a financial transaction interchange network 128 shown in FIG. 1, and may be referred to as an interchange computer system. Server system 212 may be used for processing transaction data and analyzing for fraudulent transactions. In addition, at least one of client systems 214 may include a computer system associated with an issuer of a transaction card. Accordingly, server system 212 and client systems 214 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant. In addition, client systems 214 or point of sales devices 222 may include point-of-sale (POS) devices associated with a merchant and used for processing payment transactions. At least one client system 214 may be used for investigating potential breaches.

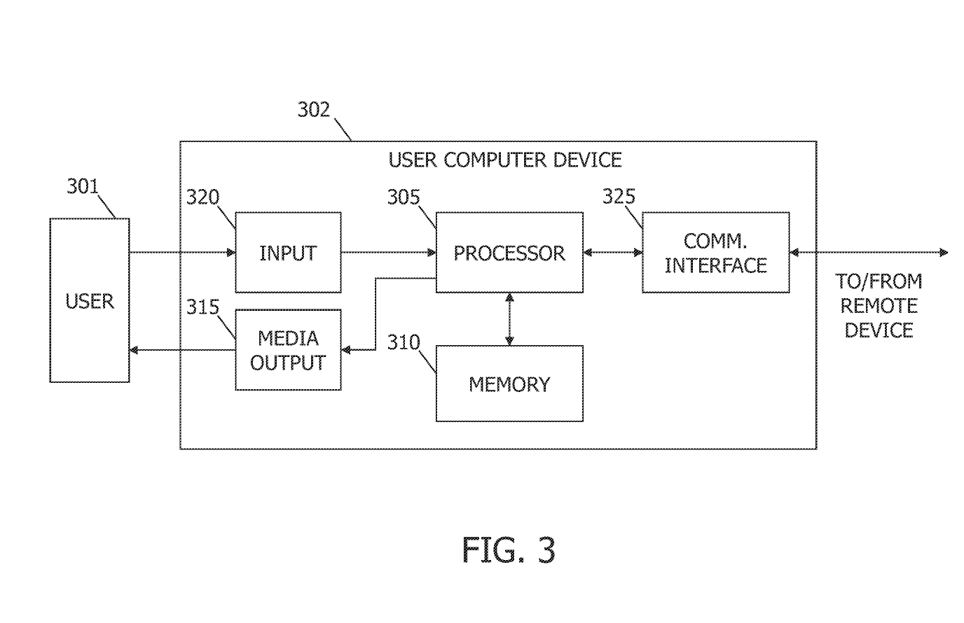

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214 and AGLA computer device 224 (both shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

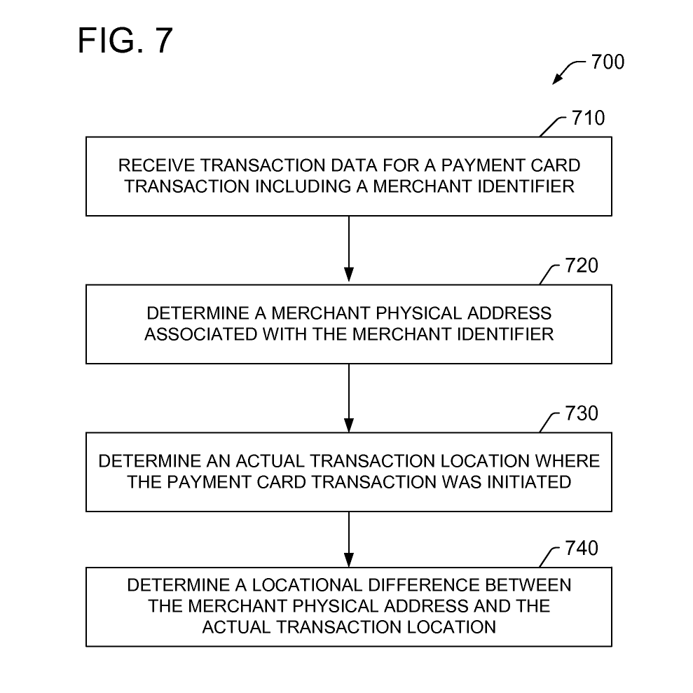

Processor 305 executes computer-executable instructions for implementing aspects of the disclosure. In some embodiments, the processor 305 is transformed into a special purpose microprocessor by executing computer-executable instructions or by otherwise being programmed For example, the processor 305 is programmed with the instruction such as illustrated in FIG. 7.

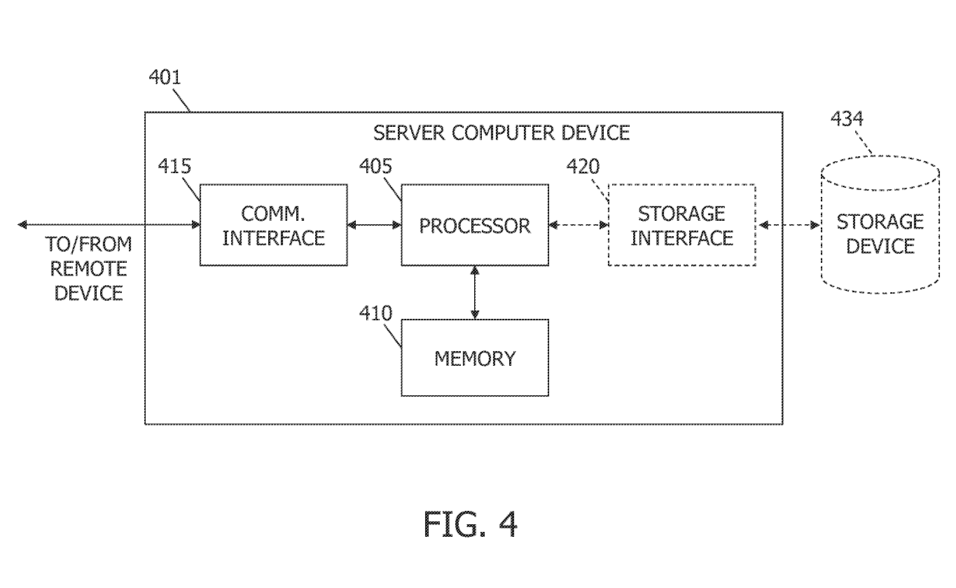

FIG. 4 illustrates an example configuration of the server system 212 shown in FIG. 2, in accordance with one embodiment of the present disclosure. Server computer device 401 may include, but is not limited to, database server 216 (shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, or AGLA computer device 224 (both shown in FIG. 2). For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

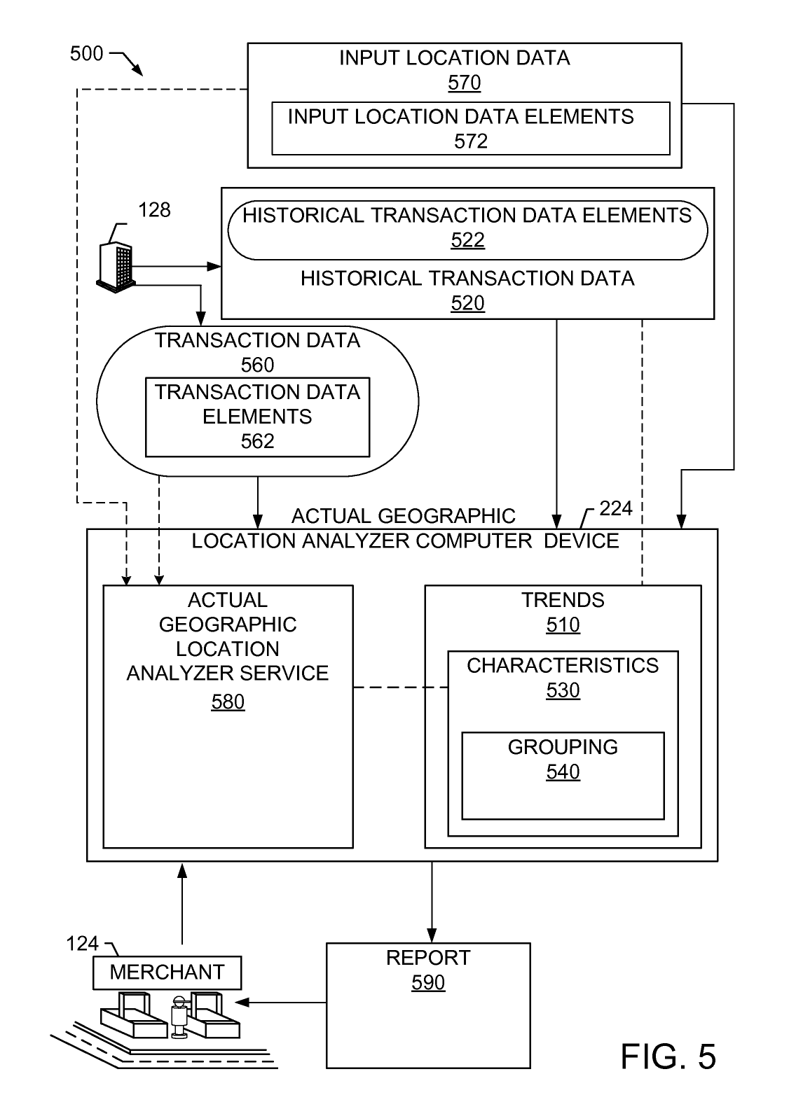

FIG. 5 is a simplified data flow diagram of a system 500 for determining the actual geographic location of a transaction in accordance with system 200 shown in FIG. 2. In the example embodiment, system 500 includes merchant 124, payment network 128, and AGLA computer device 224.

In one example embodiment, merchant 124 registers with AGLA computer device 224 before receiving access to actual geographic location analyzer service 580. When payment network 128 receives an authorization request message containing transaction data 560 from merchant 124 (as shown in FIG. 1), payment network 128 transmits the authorization request message to AGLA computer device 224. In some embodiments, payment network 128 determines whether merchant 124 is registered with actual geographic location analyzer service 580 before transmitting transaction data 560. In other embodiments, payment network 128 automatically transmits transaction data 560 to AGLA computer device 224. In other embodiments, AGLA computer device 224 is associated with payment network 128 and automatically receives transaction data as a part of normal processing of payment transactions. In the example embodiment, the authorization request message is associated with a payment card transaction where the payment card was present when the transaction occurred. Additionally, a third party, such as a government agency, may register merchant 124 with AGLA computer device 224 for actual geographic location analyzer service 580. Transaction data 560 represents the data from the processing of a payment transaction and includes one or more transaction data elements 562. Transaction data elements 562 may include, but are not limited to, transaction amounts, transaction volumes, transaction identifiers, product identifiers, cardholder residence locations, merchant physical addresses, transaction dates and times, merchant identifiers, and cardholder identifiers.

Merchant 124 may also use actual geographic location analyzer service 580 for transactions that occurred prior to the merchant's registration. When an authorization request message is received by payment network 128, payment network 128 may store the data for the transactions as historical transaction data 520 with historical transaction data elements 522. Historical transaction data elements 522 may include, but are not limited to, transaction amounts, transaction volumes, transaction identifiers, product identifiers, cardholder residence locations, merchant physical addresses, transaction dates and times, merchant identifiers, and cardholder identifiers. In at least one example embodiment, historical transaction data 520 may be stored in database 220 (shown in FIG. 2) associated with payment network 128. In alternative embodiments, historical transaction data 520 may be stored in databases 220 associated with merchant bank 126 or issuer 130 (both shown in FIG. 1). After merchant 124 registers with AGLA computer device 224 for actual geographic location analyzer service 580, AGLA computer device 224 may request historical transaction data 520 from payment network 128 or database 220 where historical transaction data 520 is being stored.

In some examples, merchant 124 may conduct business at a single location, such as a storefront. This location may be referred to as the merchant physical address. In other examples, merchant 124 may conduct business at multiple locations. In these examples, merchant 124 may report the merchant physical address to be the location merchant 124 conducts the majority of their business or merchant 124 may report a corporate address as the merchant physical address.

The AGLA computer device receives input location data 570 (also known as actual transaction location data) which includes the actual transaction location of the payment transaction for each payment card transaction. As mentioned previously, the actual transaction location is the location where the card present transaction is originating. In some examples, the actual transaction location may be the same as the merchant physical address. In other examples, a transaction may originate at a different location than the merchant physical address. In these examples, the actual transaction location may be different than the merchant physical address.

Input location data 570 includes input location data elements 572. In some embodiments, the input location data elements 572 may include latitude and longitude information, physical street addresses, geographic region, town, county, and state. In some examples, the actual geographic location elements 572 may contain a single geographic data point, such as a physical address. In other examples, the input location data elements 572 may contain multiple geographic data points. In yet other examples, the input location data elements 572 may include a geographic region, for example, a county, city, state, or other geographic region. The geographic region may also contain an area with boundary lines, such as a latitude line or a longitude line. Additionally, the input location data elements 572 may contain an event identifier, which contains data such as an event name, event dates including a begin date and an end date, and additional event organizer information. Input location data 570 represents the actual physical location of a card present payment transaction.

In one example embodiment, AGLA computer device 224 receives transaction data 560 associated a payment card transaction wherein transaction data 560 includes a merchant identifier associated with merchant 124. AGLA computer device 224 queries database 220 with merchant identifier to receive a physical address for merchant 124. AGLA computer device 224 also receives input location data 570 for the payment card transaction. AGLA computer device 224 compares the merchant physical address with input location data 570. In the example embodiment, if AGLA computer device 224 determines a locational difference between the merchant physical address and the actual geographic location that the transaction occurred at, then AGLA computer device 224 stores the locational difference.

In other embodiments, AGLA computer device 224 receives historical transaction data 520 and input location data 570 for a plurality of payment transactions. AGLA computer device 224 retrieves the merchant physical address for each transaction. In some embodiments, all of the payment transactions in historical transaction data 520 is associated with the same merchant 124 and AGLA computer device 224 uses the same physical address for all of the transactions. In other embodiments, there may be a plurality of merchants and AGLA computer device 224 organizes the transaction by merchant identifier. For each payment transaction in historical transaction data, AGLA computer device 224 compares input location data 570 with the associated merchant physical address to determine if there is a different. If AGLA computer device 224 determines a locational difference, then AGLA computer device 224 stores the locational difference.

In some examples, received transaction data 560 may not include all elements 562 and AGLA computer device 224 may use historical transaction data 520 to infer missing elements. For example, transaction data elements 562 may not include a merchant physical address. AGLA computer device 224 may determine a merchant physical address from historical transaction data 520 by comparing historical transaction data elements 522 and transaction data elements 562. More specifically, in some embodiments, AGLA computer device 224 finds similar elements, such as a merchant identifier, between the data elements. AGLA computer device 224 infers the merchant physical address from the historical transaction data's 520 merchant physical address.

In the example embodiment, AGLA computer device 224 determines a locational difference between the merchant physical address for each payment card transaction and the actual transaction location of the transaction. AGLA computer device 224 determines trends 510 based on the locational differences. Historical transaction data 520 may be enhanced to include the locational difference. In an example embodiment, AGLA computer device 224 stores the locational difference as a Boolean flag. In this instance, AGLA computer device 224 compares the merchant physical address for each payment card transaction and the actual transaction location. If the merchant physical address and actual transaction location are different, AGLA computer device 224 sets a Boolean flag. In some examples, the merchant physical address and the actual transaction location received by the computer system may be a single geographic data point, such as a physical address. However, in other examples, AGLA computer device 224 may receive the merchant physical address as a single geographic data point, but the actual transaction location received may be a latitude and longitude. In this situation, AGLA computer device 224 may modify the latitude and longitude to an address. In yet other examples, the computer system may receive the merchant physical address as a single geographic data point and receive the actual transaction location as a county. In other examples, the locational difference between the merchant physical address and the actual transaction location may be stored as a vector indicating the distance and direction between the two locations. The distance may be computed by calculating the driving distance between the two points. This can be useful when physical barriers, such as mountains or bodies of water, would skew the actual distance between the two points.

AGLA computer device 224 may deliver a report 590 based upon the locational difference between the merchant physical address for each payment card transaction and the actual transaction location of the transaction. More specifically, AGLA computer device 224 processes transaction data 560, input location data 570, and the locational difference to generate report 590. AGLA computer device 224 may use the historical transaction data 520 to generate report 590. AGLA computer device 224 may standardize the actual geographic locations. In one embodiment, AGLA computer device 224 may convert the actual geographic location and merchant physical address to latitude and longitude. In another embodiment, the AGLA computer device 224 may convert the actual transaction location and merchant physical address to a geographic region.

In some embodiments, AGLA computer device 224 uses historical transaction data 520 to calculate a merchant's yearly revenue. In other embodiments, AGLA computer device 224 uses historical transaction data 520 to calculate the revenue earned by a particular product. To calculate this revenue, AGLA computer device 224 uses the transaction amounts, product identifiers, transaction volumes, and merchant identifiers. In the example embodiment, AGLA computer device analyzes and identifies trends 510 from historical transaction data 520 using algorithms. Trends 510 may be used to identify business concerns and opportunities. Trends 510 may include historical transaction data elements 522. Further, historical transaction data elements 522 may be put in groupings 540 to allow the AGLA computer device 224 to distinguish characteristics 530 in different conditions. For example, the actual transaction location may be put in groupings to include all transactions outside the merchant physical address. A first illustrative trend is displayed below (Table 1):

TABLE 1

| Location of | Transaction | Transaction |
|---|---|---|
| Sale for a | Volumes for | amounts for |
| Merchant | previous year | previous year |
| Location | 100,000,000 | $200,000 |
| Outside of | | |
| Merchant | | |
| Physical | | |
| Address | | |
| Merchant | 5,000,000 | $100,000 |
| Physical | | |
| Address | | |

Table 1 serves as a first illustration of a simple form of a trend 510. AGLA computer device 224 may group 540 the historical transaction data 520 by identical merchant identifiers. AGLA computer device 224 may further group 540 the historical transaction data 520 by transactions occurring within the previous year. Transaction volumes and transaction amounts may be added together from this further grouping 540. The Boolean flag locational difference may differentiate between location outside of merchant physical address and the merchant physical address for transaction volumes and transaction amounts. A second illustrative trend is displayed below (Table 2):

TABLE 2

| Location of | Transaction | Transaction |
|---|---|---|
| Sale for | Volumes for | amounts for |
| Merchant | Event | Event |
| Craft Fair 1 | 1,000 | $5,000 |
| Craft Fair 2 | 2,500 | $2,500 |
| Craft Fair 3 | 400 | $1,000 |
| Craft fair 4 | 1,300 | $2,000 |

The example trends 510 indicated in Tables 1 and 2 are provided for explanation only. They are not restrictive and it should be understood that the trends generated and used by AGLA computer device 224 may be significantly different and more complex than the trends illustrated above. In the example of Table 2, AGLA computer device 224 may group 540 the historical transaction data 520 by identical merchant identifiers. AGLA computer device 224 may further group 540 the historical transaction data 520 by event identifier, such as event name. Transaction volumes and transaction amounts may be added together from this further grouping 540.

In further examples, AGLA computer device 224 may analyze historical transaction data 520 to identify patterns of characteristics 530. Where characteristics 530 significantly deviate from the normal characteristics, AGLA computer device 224 may flag or otherwise identify such deviations.

The trends and deviations may be used to identify business concerns and opportunities. AGLA computer device 224 may create and deliver report 590 to merchant 124. Report 590 may be delivered to merchant 124 upon request or periodically. Additionally, AGLA computer device 224 may deliver report 590 upon a numerical accumulation of the locational differences. In other words, the locational differences between the merchant address and the actual geographic location for a particular merchant identifier may be accumulated. Once the locational differences reach a numerical value, AGLA computer device 224 may deliver report 590 to merchant 124.

In some embodiments, the AGLA computer device determines if the payment transaction was a card present transaction before looking for an actual transaction location. For example, if the AGLA computer device determines that the payment transaction was an online ecommerce transaction, then the AGLA computer device does not determine an actual transaction location for the payment transaction.

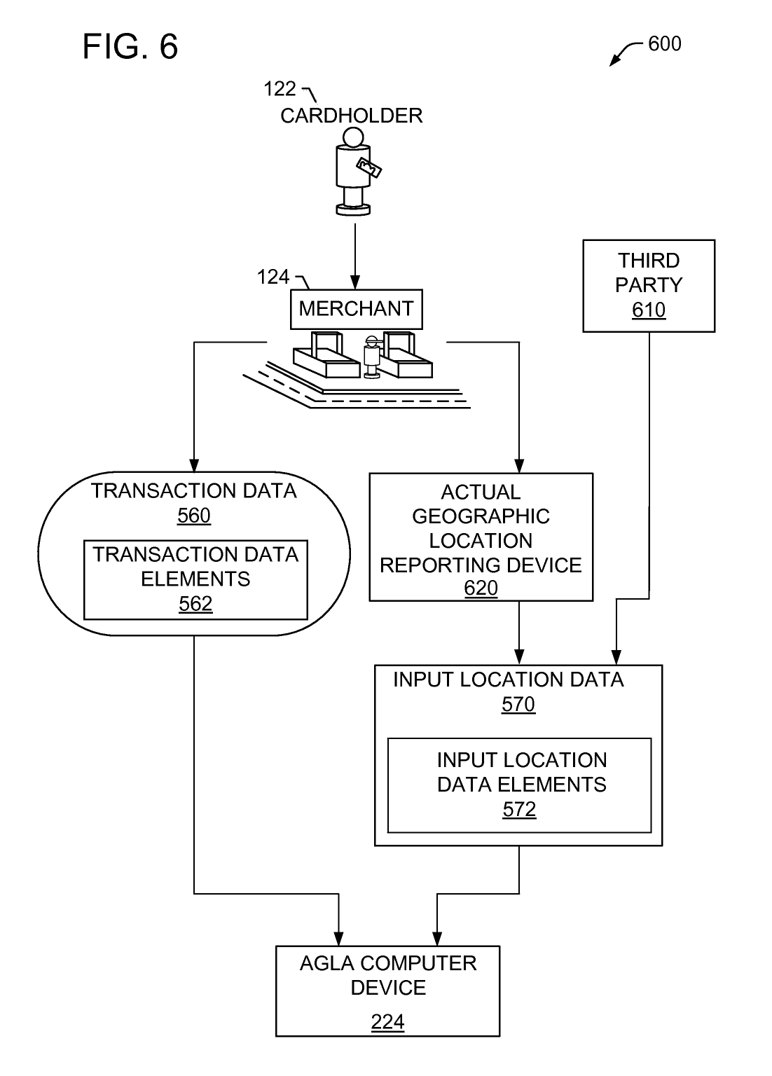

FIG. 6 is a schematic diagram illustrating a system 600 for obtaining the actual geographic location of the transaction using system 200 shown in FIG. 2, in accordance with one embodiment of the disclosure. In the example embodiment, after cardholder 122 makes a purchase with merchant 124, transaction data 560 related to the purchase is transferred among the parties to the transaction, as shown in FIG. 1, to AGLA computer device 224. Additionally, merchant 124, using an actual geographic location reporting device 620, transfers input location data 570 indicating the actual transaction location to AGLA computer device 224. In some embodiments, actual geographic location reporting device 620 may be client system 214 shown in FIG. 2.

In some example embodiments, actual geographic location reporting device 620 uses Global Positioning Service (GPS) data, wherein the GPS function is provided by the merchant's POS device or the cardholder's mobile device. In other embodiments, actual geographic location reporting device 620 may obtain the actual transaction location by cell network triangulation, physical addresses from mapping software, social media “check-ins”, and physical addresses associated with IP address. Additionally, the actual transaction location may be provided by merchant 124 or a third party 610, such as taxi records or craft fair locations, by inputting this data into AGLA computer device 224.

In an example embodiment, AGLA computer device 224 enhances transaction data 560 to include the actual geographic location at the time of the transaction. In some examples, AGLA computer device 224 the actual transaction location replaces the merchant physical address associated with the transaction data elements 562. In other examples, the actual transaction location replaces the cardholder residence location associated with transaction data elements 562. In yet other examples, the actual transaction location may be an additional data element added along with transaction data 560.

In another embodiment, merchant 124 reports the actual geographic location of the transaction after the transaction is completed. In the example embodiment, Merchant 124 may use a client system 214 (shown in FIG. 4) to submit the input location data 570 including input location data elements 572 such as a transaction identifier, a merchant identifier, and an actual geographic location. AGLA computer device 224 may compare the merchant's submitted input location data elements 572 and with historical transaction data elements 522. If the certain elements match, such as the merchant identifiers and the transaction identifiers, the AGLA computer device 224 may enhance or modify transaction data 560 to include the actual transaction location. A person of ordinary skill in the art would recognize linking merchant reported input location data 570 and historical transaction data 520 may be accomplished many other ways, such as merchant 124 submitting a date of purchase and a time of purchase instead of the transaction identifier. Merchant 124 may also submit a date of purchase and an amount of purchase instead of the transaction identifier.

In another embodiment, AGLA computer device 224 may receive input location data 570 from third party 610. Examples of third parties 610 may include cell phone providers, event organizers, GPS providers, and merchant banks 126 (shown in FIG. 1). In some examples, third party 610 may transmit, at the time of the transaction, input location data 570 to the AGLA computer device 224. In other examples, AGLA computer device 224 may receive, after receiving transaction data 560, input location data 570 from third party 610. In yet other examples, third party 610 may collect and maintain input location data 570 for a plurality of transactions. Third party 610 may create a report from input location data 570 from the plurality of transactions and deliver the report to AGLA computer device 224. The report may be delivered to AGLA computer device 224 periodically or upon request.

FIG. 7 is a flowchart illustrating an example of a process 700 of determining the actual geographic location of a payment transaction using system 200 shown in FIG. 2, in accordance with one embodiment of the disclosure. Process 700 may be implemented by a computing device, for example AGLA computer device 224 (shown in FIG. 2). In the example embodiment, AGLA computer device 224 receives 710 transaction data 560 (shown in FIG. 5) for a payment card transaction, where transaction data 560 includes transaction data elements 562 (shown in FIG. 5) including a merchant identifier. AGLA computer device 224 determines 720 a merchant physical address associated with the received merchant identifier. In some embodiments, AGLA computer device 224 uses the merchant identifier to query database 220 for the merchant physical address. In some embodiments, AGLA computer device 224 stores a plurality of merchant identifiers and associated merchant physical addresses. In these embodiments, AGLA computer device compares the received merchant identifier to the stored merchant identifiers to determine 720 the merchant physical address.

AGLA computer device 224 determines 730 an actual transaction location where the payment card transaction was initiated. In the example embodiment, AGLA computer device 224 receives input location data 570 (shown in FIG. 5) and uses the input location data 570 to determine the actual transaction location as described in FIG. 6. AGLA computer device 224 determines 740 a locational difference between the merchant physical address and the actual transaction location. In the example embodiment, AGLA computer device 224 stores the locational difference.

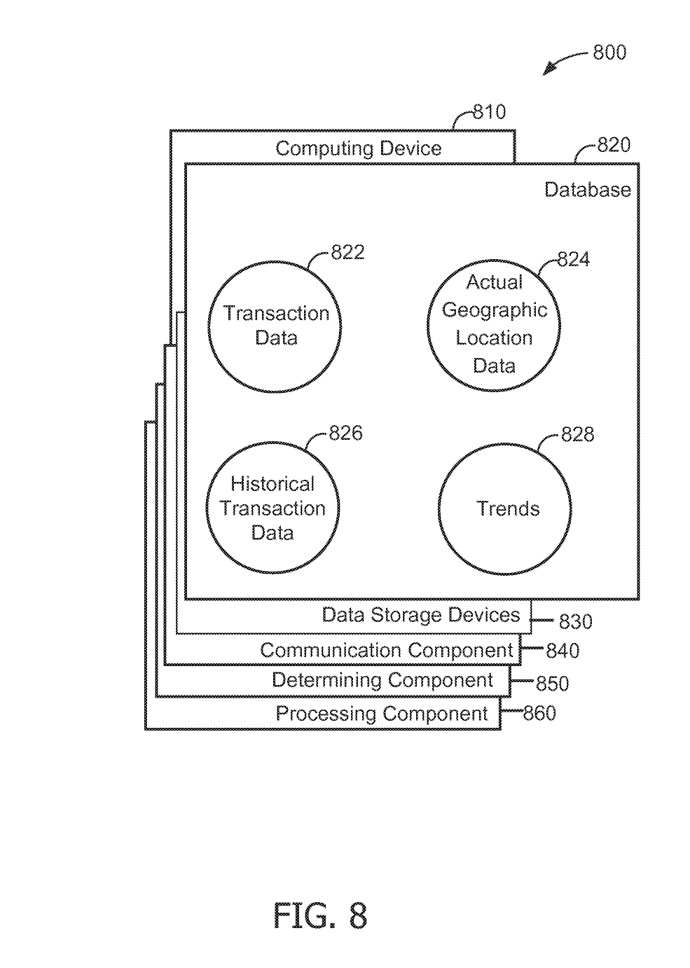

FIG. 8 is a diagram 800 of components of one or more example computing devices that may be used in system 200 shown in FIG. 2. In some embodiments, computing device 810 is similar to server system 212; it may also be similar to AGLA computer device 224 (both shown in FIG. 2). Database 820 may be coupled with several separate components within computing device 810, which perform specific tasks. In this embodiment, database 820 includes transaction data 822 which may be transaction data 560 shown in FIG. 5, actual geographic location data 824 which may be input location data 570 shown in FIG. 5, historical transaction data 826 which may be historical transaction data 520 shown in FIG. 5, and trends 828 which may be trends 510 shown in FIG. 5. In some embodiments, database 820 is similar to database 220 (shown in FIG. 2).

Computing device 810 includes the database 820, as well as data storage devices 830. Computing device 810 also includes a communication component 840 for receiving 710 transaction data (shown in FIG. 7). Computing device 810 also includes a determining component 850 for determining 720 a merchant physical address, determining 730 an actual transaction location, and determining 740 a locational difference, all shown in FIG. 7. A processing component 860 assists with execution of computer-executable instructions associated with the system.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal languages of the claims.

What is claimed is:

1. A computer-implemented method for determining an actual geographic location of a payment transaction, the method implemented using an actual geographic location analyzer computer device in communication with a memory, the method comprising:
storing, in the memory, merchant data including a merchant physical address;
receiving transaction data for a payment card transaction wherein the transaction data includes a merchant identifier;
determining a merchant physical address associated with the merchant identifier;
determining, by the actual geographic location analyzer computer device, an actual transaction location, wherein the actual transaction location identifies where the payment card transaction was initiated; and
determining, by the actual geographic location analyzer computer device, a locational difference between the merchant physical address and the actual transaction location.

2. The method of claim 1, wherein determining an actual transaction location further comprises:
receiving input location data representing the actual transaction location of the payment card transaction; and
determining the actual transaction location based on the input location data.

3. The method of claim 2, wherein the input location data includes one of global positioning service data, cell network triangulation, a physical address from mapping software, one or more social media “check-ins”, a physical address associated with an IP address, event location data, starting and ending dates, latitude and longitude, a street address, a city, a county, a state, and a geographic region.

4. The method of claim 2, wherein the transaction data is an authorization request message originating from a point of sale device associated with the merchant identifier, and where the authorization request message includes the input location data provided by the point of sale device.

5. The method of claim 2, wherein the transaction data originates from a point of sale device associated with the merchant identifier, and wherein the input location data originates from a third party.

6. The method of claim 1, further comprising combining the transaction data for the payment card transaction with the actual transaction location associated with the payment card transaction.

7. The method of claim 1, further comprising:
storing a plurality of transaction data associated with a plurality of payment card transactions including a first payment card transaction;
receiving a first actual transaction location;
determining that the first actual transaction location is associated with the first payment card transaction; and
updating the transaction data associated with first payment card transaction to include the first actual transaction location.

8. The method of claim 1, further comprising:
storing a plurality of transaction data associated with a plurality of payment card transactions, wherein the plurality of transaction data includes a plurality of actual transaction locations;
calculating at least one trend based on the plurality of actual transaction locations;
generating a report based on the at least one trend; and
providing the report.

9. The method of claim 1, wherein determining a locational difference further comprises generating a vector from the merchant physical address and the actual transaction location.

10. The method of claim 9, wherein generating a vector is based on driving directions between the merchant physical address and the actual transaction location.

11. The method of claim 1, further comprising:
determining that the merchant physical address is in a first format and the actual transaction location is in a second format; and
converting the actual transaction location from the second format to the first format.

12. The method of claim 1, wherein the payment card transaction is a card present transaction.

13. An actual geographic location analyzer computer device used to determine an actual geographic location of a payment transaction, said actual geographic location analyzer computer device comprising a processor communicatively coupled to a memory device, said processor programmed to:
store merchant data including a merchant physical address;
receive transaction data for a payment card transaction wherein the transaction data includes a merchant identifier;
determine a merchant physical address associated with the merchant identifier;
determine an actual transaction location, wherein the actual transaction location identifies where the payment card transaction was initiated; and
determine a locational difference between the merchant physical address and the actual geographic location.

14. An actual geographic location analyzer computer device in accordance with claim 13 wherein said processor is further programmed to:
receive input location data representing the actual transaction location of the payment card transaction; and
determine the actual transaction location based on the input location data.

15. An actual geographic location analyzer computer device in accordance with claim 14 wherein the input location data includes one of global positioning service data, cell network triangulation, a physical address from mapping software, one or more social media “check-ins”, a physical address associated with an IP address, event location data, starting and ending dates, latitude and longitude, a street address, a city, a county, a state, and a geographic region.

16. An actual geographic location analyzer computer device in accordance with claim 14 wherein the transaction data is an authorization request message originating from a point of sale device associated with the merchant identifier, and where the authorization request message includes the input location data provided by the point of sale device.

17. An actual geographic location analyzer computer device in accordance with claim 13 wherein said processor is further programmed to:
store a plurality of transaction data associated with a plurality of payment card transactions including a first payment card transaction;
receive a first actual transaction location;
determine that the first actual transaction location is associated with the first payment card transaction; and
update the transaction data associated with first payment card transaction to include the first actual transaction location.

18. An actual geographic location analyzer computer device in accordance with claim 13 wherein said processor is further programmed to:
store a plurality of transaction data associated with a plurality of payment card transaction, wherein the plurality of transaction data includes a plurality of actual transaction locations;
calculate at least one trend based on the plurality of actual transaction locations;
generate a report based on the at least one trend; and
provide the report.

19. At least one non-transitory computer-readable storage media having computer-executable instructions embodied thereon, wherein when executed by an actual geographic location analyzer computer device having at least one processor coupled to at least one memory device, the computer-executable instructions cause the processor to:
store merchant data including a merchant physical address;
receive transaction data for a payment card transaction wherein the transaction data includes a merchant identifier;
determine a merchant physical address associated with the merchant identifier;
determine an actual transaction location, wherein the actual transaction location identifies where the payment card transaction was initiated; and
determine a locational difference between the merchant physical address and the actual geographic location.

20. The computer-readable storage medium of claim 18, wherein the transaction data is an authorization request message originating from a point of sale device associated with the merchant identifier and wherein the computer-executable instructions further cause the processor to:
process input location data representing the actual transaction location of the payment card transaction, wherein the authorization request message includes the input location data provided by the point of sale device; and
determine the actual transaction location based on the input location data.
